(19) United States
(12) Patent Application Publication
(10) Pub. No.: US 2024/0330696 A1
(43) Pub. Date: Oct. 3, 2024

(54) TRAINING POLICY USING DISTRIBUTIONAL REINFORCEMENT LEARNING AND CONDITIONAL VALUE AT RISK

(71) Applicant: INTERNATIONAL BUSINESS MACHINES CORPORATION, Armonk, NY (US)

(72) Inventors: Takayuki Osogami, Yamato-shi (JP); Lan Ngoc Hoang, Timperley (GB)

(21) Appl. No.: 18/192,650

(22) Filed: Mar. 30, 2023

(51) Int. Cl. G06N 3/092; G06N 3/0455

(52) U.S. Cl. CPC G06N 3/092; G06N 3/0455

(57) ABSTRACT

A computer-implemented method for modifying a current policy using reinforcement learning (RL) includes the following operations. A number, corresponding to an inputted sample size, of Markov Decision Processes (MDPs) defining an environment are sampled. For each of the sampled MDPs, behavior data for the current policy is collected, a quantile function of return with the current policy is determined using the collected behavior data, and a current weight is generated by updating a weight for a particular sampled MDP using the quantile function of return for the particular sampled MDP. The policy is modified based upon the weights for each of the sampled MDPs. The current weights are generated by minimizing a conditional value of at risk (CVaR) of a return of the current policy, and the policy is modified to maximize a weighted average of the CVaR of the return with the current weights.

### BACKGROUND

The present invention relates to machine learning, and more specifically, to training a policy using distributional reinforcement learning and conditional value at risk.

Navigation of robots, vehicles, etc. involves sequential decision making under uncertainties, in which artificial intelligence (AI) agents need to continuously learn from past experiences and adapt their current actions accordingly. For example, an AI-controlled vehicle may adjust the speed of the vehicle (i.e., as an action) based upon the road conditions (i.e., the environment). As another example, an AI agent may be conducting a chat dialogue. In these instances, the AI agent needs to learn from the interactions and adapt its actions accordingly within that episode (i.e., while the agent is interacting with the environment). Many types of machine learning technologies used to train an AI agent include supervised learning (SL), unsupervised learning (UL), and reinforcement learning (RL). RL differs from SL by not requiring labeled input/output pairs and not requiring sub-optimal actions to be explicitly corrected. FIG. 1A illustrates a typical RL architecture 100.

In describing RL, the following terms are oftentimes used. The “Agent” refers to software programs that make intelligent decisions, and the agents are the learners in RL. These agents interact with the environment by actions and receive rewards based upon those actions. The “Environment” refers to the real-world (or simulated) environment with which the agent interacts. The “State” (Sₜ) refers to a current situation/position of the agent. Each State (Sₜ) may have one or more dimensions that describe the State. The “reward” (Rₜ) is feedback from the environment (also illustrated as “r” in FIG. 2B), which is used to evaluate actions (Aₜ) taken by the agent.

A reward function, which is part of the environment, generates the reward (Rₜ), and the reward function reflects the desired goal of the model being trained. The “policy” (π) is a methodology by which to map the State (Sₜ) of the agent to certain actions (Aₜ). Formally, the policy π(s) is defined as the suggested action (or a probability distribution of actions) that the agent should take for every possible state s∈S. In short, the policy is the strategy employed by the agent in pursuit of the desired goal. The “value” is a future reward received by an agent by taking an action (Aₜ) in a particular State (Sₜ). Ultimately, the goal of the agent is to generate actions (Aₜ) that maximize the value.

Markov Decision Process (MDP) is a standard model for sequential decision making under uncertainty and is frequently used as part of RL. A Markov decision process (MDP) can be defined as a tuple M=(S, A, R, T, T₀, γ, H) with S is a set of states, A is set of actions, R (rₜ₊₁|sₜ, aₜ, sₜ₊₁) is a reward function, T(sₜ₊₁|sₜ, aₜ) is a transition function, T₀(s₀) is an initial state distribution, γ is a discount factor, and H is the horizon. In a standard RL setting, a policy π is learned that maximizes some cumulative function of the random rewards, which is typically the expected discounted sum over the defined horizon.

A problem with RL in learning a policy that maximizes some expected cumulative reward is that this approach can neglect rare but catastrophic occurrences in mission-critical applications with risk-sensitive tasks such as autonomous driving. The term “tail risk” refers to the chance of a loss occurring due to a rare event, as predicted by a probability distribution. Tail risk typically refers to occurrences of an event that happen outside of three deviations from the mean.

Two types of uncertainties are oftentimes associated with RL. Epistemic uncertainty refers to uncertainty that is caused by lack of knowledge about the workings of a particular environment, and aleatoric uncertainty refers to uncertainty resulting from the randomness associated with the working of the environment. The differences between these two types of uncertainties have different implications in sequential decision making. The source of epistemic uncertainties is lack of knowledge, and consequently, some epistemic uncertainties can be resolved as more knowledge is obtained over time via additional trial and observations during RL. However, since aleatoric uncertainties are inherent to the randomness of the environment, additional knowledge about the environment does not ameliorate these deficiencies.

While most past approaches to addressing uncertainty in RL have only considered aleatoric uncertainty, there have been some approaches that have focused solely on epistemic uncertainties. One approach for addressing both types of uncertainties involves the determination of a Bayes-optimal policy. When learning in an unknown environment, there is a need to perform exploration (i.e., learn about the environment) and exploitation (i.e., take promises actions), which is accomplished by the Bayes-optimal policy. In so doing, a policy can be generated that conditions actions not only on the current state (as in a normal RL policy) but also on the agent's uncertainty about the environment itself.

A Bayes-adaptive Markov Decision Processes (BAMDP) is one approach for determining a Bayes-optimal policy. In BAMDP, the Bayesian setting has a prior distribution q over the space M of MDPs. The MDPs in M are assumed to have a common state space S and a common action space A, and q may be considered as the prior distribution of (p₀; p). This Bayesian setting is referred to as BAMDP and specified with a tuple (S; A; q). In a BAMDP, a MDP M is sampled according to q in the beginning of an episode, and the agent interacts with M throughout the episode. The agent is not informed of which MDP has been sampled but can learn its posterior distribution on the basis of the observations (i.e., the history of states, actions, and rewards) during the episode. The agent will adapt its actions according to the observations to achieve its objective.

A known improvement to BAMDP is Variational Bayes-Adaptive Deep RL (VariBAD), which is an approach to performing approximate inference in an unknown environment and to incorporate task uncertainty directly during action selection. An architecture 100 employing VariBAD is illustrated with regard to FIG. 2. As illustrated, a trajectory of states s, actions a and rewards r is processed online using a Recurrent Neural Network (RNN) to produce the posterior over task embeddings, q_{ϕ}(m|τ_{:t}). The posterior p(R, T|τ_{:t}) is trained using a decoder Dec_{ϕ} 120 which attempts to predict past and future states and rewards from current states and actions. The policy conditions on the posterior in order to act in the environment and is trained using a neural network 130 employing RL. The policy π_{ψ} is made history-dependent by providing, as an input to the policy, the belief vector by and state sₜ. The history hₜ of observations is encoded into the belief using a variational auto-encoder (VAE), which includes the trained encoder Enc_{ϕ} 110 and decoder Deca 120. The decoder Dec_{ϕ} 120 maps the belief vector bₜ into a next state sₜ and next immediate reward rₜ. The encoder Enc_{ϕ} 110 and decoder Dec_{ϕ} 120 can be implemented using neural networks.

### SUMMARY

A computer-implemented process for modifying a current policy using reinforcement learning (RL) includes the following operations. A number, corresponding to an inputted sample size, of Markov Decision Processes (MDPs) defining an environment are sampled. For each of the sampled MDPs, behavior data for the current policy is collected, a quantile function of return with the current policy is determined using the collected behavior data, and a current weight is generated by updating a weight for a particular sampled MDP using the quantile function of return for the particular sampled MDP. The policy is modified based upon the weights for each of the sampled MDPs. The current weights are generated by minimizing a conditional value of at risk (CVaR) of a return of the current policy, and the policy is modified to maximize a weighted average of the CVaR of the return with the current weights.

In other aspects of the process, a variational auto-encoder (VAE) including an encoder and a decoder is optimized using the collected behavior data, and the VAE is optimized by maximizing an evidence lower bound (ELBO). Additionally, the sampled MDPs are sampled based upon a prior distribution of the environment. Also, the weight is updated by solving an optimization problem. The quantile function of return is determined using distributional RL. The behavior data is determined for the current policy by interacting with the environment using the current policy.

A computer hardware system for modifying a current policy using reinforcement learning (RL) includes a hardware processor configured to perform the following operations. A number, corresponding to an inputted sample size, of Markov Decision Processes (MDPs) defining an environment are sampled. For each of the sampled MDPs, behavior data for the current policy is collected, a quantile function of return with the current policy is determined using the collected behavior data, and a current weight is generated by updating a weight for a particular sampled MDP using the quantile function of return for the particular sampled MDP. The policy is modified based upon the weights for each of the sampled MDPs. The current weights are generated by minimizing a conditional value of at risk (CVaR) of a return of the current policy, and the policy is modified to maximize a weighted average of the CVaR of the return with the current weights.

In other aspects of the hardware system, a variational auto-encoder (VAE) including an encoder and a decoder is optimized using the collected behavior data, and the VAE is optimized by maximizing an evidence lower bound (ELBO). Additionally, the sampled MDPs are sampled based upon a prior distribution of the environment. Also, the weight is updated by solving an optimization problem. The quantile function of return is determined using distributional RL. The behavior data is determined for the current policy by interacting with the environment using the current policy.

A computer program product includes a computer readable storage medium having stored therein program code for modifying a current policy using reinforcement learning (RL) is disclosed. The program code, which when executed by computer hardware system, cause the computer hardware system to perform the following. A number, corresponding to an inputted sample size, of Markov Decision Processes (MDPs) defining an environment are sampled. For each of the sampled MDPs, behavior data for the current policy is collected, a quantile function of return with the current policy is determined using the collected behavior data, and a current weight is generated by updating a weight for a particular sampled MDP using the quantile function of return for the particular sampled MDP. The policy is modified based upon the weights for each of the sampled MDPs. The current weights are generated by minimizing a conditional value of at risk (CVaR) of a return of the current policy, and the policy is modified to maximize a weighted average of the CVaR of the return with the current weights.

In other aspects of the computer program product, a variational auto-encoder (VAE) including an encoder and a decoder is optimized using the collected behavior data, and the VAE is optimized by maximizing an evidence lower bound (ELBO). Additionally, the sampled MDPs are sampled based upon a prior distribution of the environment. Also, the weight is updated by solving an optimization problem. The quantile function of return is determined using distributional RL. The behavior data is determined for the current policy by interacting with the environment using the current policy.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is a flowchart of a typical reinforcement learning (RL) approach.

FIG. 2 is a block diagram illustrating a VariBAD architecture.

FIG. 3 is a block diagram illustrating a modified VariBAD architecture according to at least one embodiment of the present invention.

FIG. 4 illustrates an example method using the architecture of FIG. 3 according to at least one embodiment of the present invention.

FIGS. 5A-B illustrate an example method using the architecture of FIG. 3 according to at least one embodiment of the present invention.

FIGS. 6A-D are graphs illustrating performance differences between the VariBAD architecture and the modified VariBAD architecture of FIG. 3.

FIG. 7 is a block diagram illustrating an example of computer environment for implementing the methodology of FIGS. 4 and 5A-B.

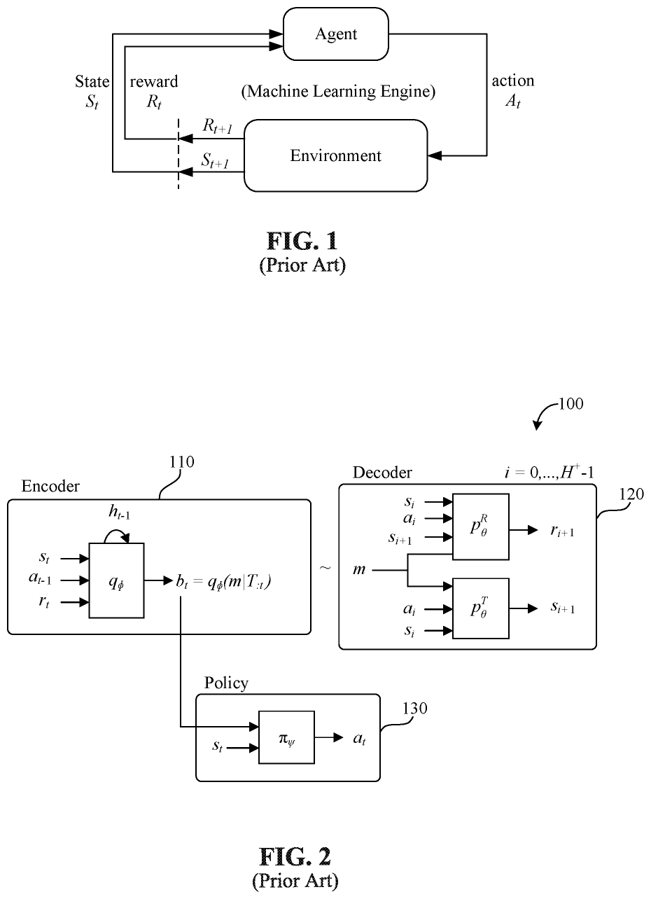

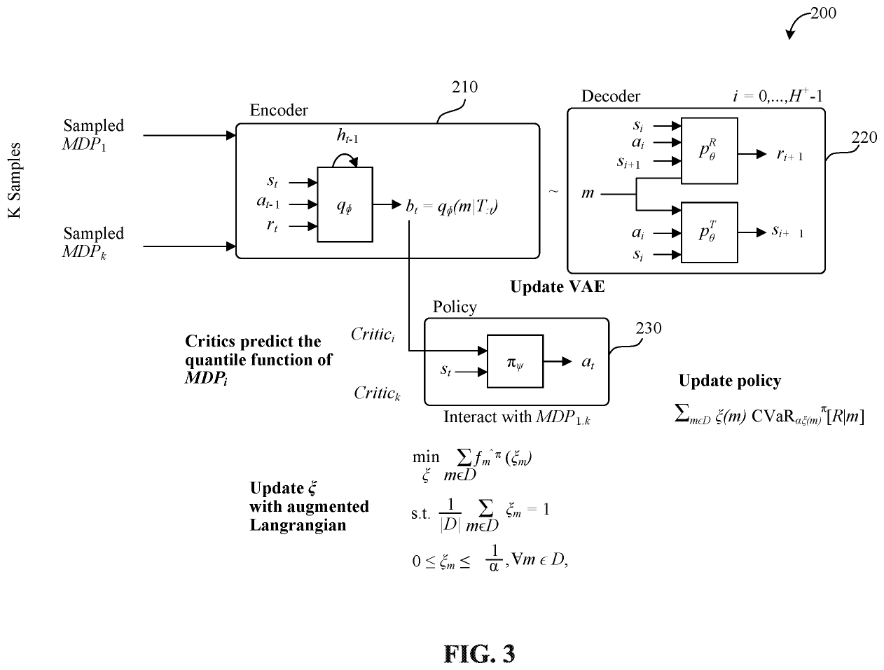

### DETAILED DESCRIPTION

The present disclosure provides a technique to reduce the computational complexity in risk-sensitive RL for BAMDP. This is accomplished by using conditional value at risk (CVaR). Additionally, the present disclosure provides a technique to reduce the computational complexity in dealing with the Bellman-like recursive equation for CVaR, which is one of the standard techniques in CVaR optimization with RL and has also been used for BAMDP. The Bellman-like equation for CVaR permits the CVaR of the return to be computed from a state by the use of the CVaR of the return from its subsequent states. Unlike the standard Bellman equation, however, the parameters of the risk-sensitivity for the CVaR from the subsequent states are given as a solution to an optimization problem. However, solving this optimization problem would require evaluating the CVaR of the return from each subsequent state with different values of risk-sensitivity, which can result in computational intractability. Computational intractability refers to a problem for which there is no efficient solution. Although an intractable problem can have a solution, this solution is a brute force method, and can limit the applicability of RL to simplistic problems.

The present disclosure leverages distributional RL. In typical RL, the expected return from applying a policy to a particular state is determined by a value function that returns a scalar value. Distributional RL differs from typical RL in that distributional RL aims to model the distribution over returns, whose mean is the traditional value function. The return distribution characterizes the probability of different returns that can be obtained as an agent interacts with its environment from a given state. According to the present disclosure, distributional RL is used to learn distribution of the return and compute the CVaR of the return with a particular value of risk-sensitivity a. A benefit of this approach is that it substantially reduces computational complexity, as the need for computing the CVaR of the return (recursively) at many different values of risk-sensitivity is eliminated.

The present disclosure involves a Bayesian setting involving an MDP M=(S; A; p₀; p) and a policy π for M. S is a (random) state in the state space and S′ is the next state under the policy π. For a BAMDP (S, A, q), the CVaR of the discounted cumulative reward R under a policy π is the following:

$${CVaR}_{α}^{π , q} [ R ] = {min}_{ξ ∈ {𝒰}_{α , q}} {𝔼}^{q} [ ξ ( M ) {CVaR}_{αξ ( M )}^{π} [ R \vert M ] ] \qquad EQUATION 1$$

where [symbol] ^{q} is the expectation with respect to q. The problem of finding a policy π that maximizes the CVaR can then be reduced to:

$${max}_{π ∈ Π} {CVaR}_{α}^{, q} [ R ] = {max}_{π ∈ Π} {min}_{ξ ∈ {𝒰}_{α , q}} f ( π , ξ )$$

where

$$f ( π , ξ ) = {𝔼}^{q} [ ξ ( M ) {CVaR}_{αξ ( M )}^{π} [ R \vert M ] ] \qquad EQUATION 2$$

is convex in ξ and concave in π. Additionally, Π and [symbol] _{α,q} are convex, and

$${𝒰}_{α , q} ≡ \{ ξ \vert ξ ( m ) ∈ [ 0 , \frac{1}{α} ] , ∀ m ∈ ℳ ; {\sum }_{m ∈ ℳ} ξ ( m ) q ( m ) = 1 \}$$

When the set of histories is finite, II is compact since it is the interaction of a compact set and convex sets. Under these assumptions, the problem of finding the policy that maximizes CVaR can be reduced to a saddle point problem, which can be solved using a framework in which π and ξ are iteratively updated. In particular, the framework involves:
1. Update ξ∈ [symbol] _{α,q} to reduce f(π,ξ).
2. Update π∈Π to increase f(π,ξ).

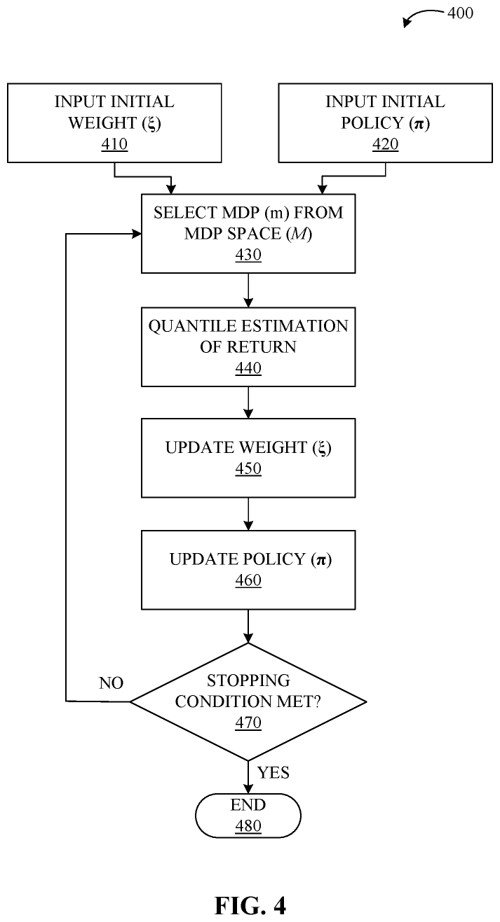

The present disclosure involves evaluating the distribution of the return (discounted cumulative reward), by running a distributional policy evaluation once and compute the CVaR with varying values of risk-sensitivity from that distribution by learning implicit quantile networks using, for example, known techniques. A methodology 400 employing this framework is illustrated in FIG. 4. In 410, an initial weight ξ is input, and in 420, an initial policy π is input. In 430 a MDP m from the MDP space M is selected (i.e., m∈M). In 430, for the selected MDP m, a quantile function of return Fₘ⁻¹ with π on m is determined.

In 440, the weight ξ is updated for a given policy π in a manner that f(π, ξ) is reduced. This can be accomplished as follows:

$${ξ}^{*} = arg {min}_{ξ ∈ {𝒰}_{α , q}} f ( π , ξ ) \qquad EQUATION 3$$

by solving linearly constrained convex minimization via an augmented Lagrangian method. Alternatively, the convex function can be approximated with a piecewise linear function and find its minimizer with linear program using known techniques.

In 450, the policy π is updated for a given policy π in a manner that increased f(π, ξ), which is the weighted average performance of the current policy π over the MDP space M. This can be accomplished by evaluation Equation 2 using the quantile function of return Fₘ⁻¹ from operation 430.

In 470, if a stopping condition is not met, the process returns to 430 in which another MDP m from the MDP space M is selected. Otherwise, the process ends at 480. Examples of stopping conditions can include, but are not limited to: a predetermined number of iterations is reached, a predetermined time limit is reached, the differences between the policy in the previous iteration and the current policy is smaller than a predetermined threshold value, and/or the difference between the weight in the previous iteration and the current weight is smaller than a predetermined threshold value.

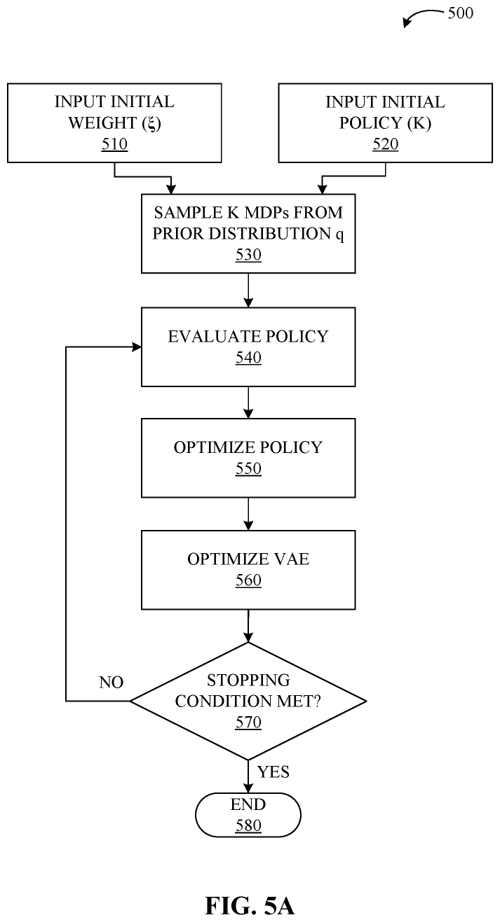

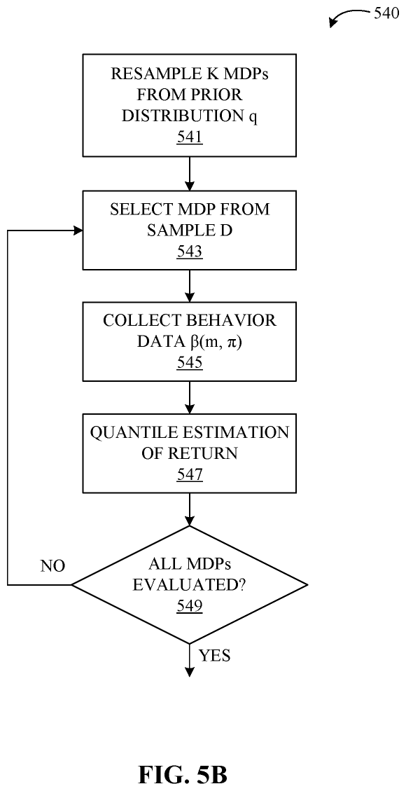

Although the process 400 of FIG. 4 represents an improvement over prior approaches, process 400 can be intractable. In particular, when |M| is large the policy π cannot be evaluated for all m∈M. Also, this process 400 becomes intractable to precisely represent history-dependent policies as the history becomes larger. Consequently, the process 500 illustrated in FIGS. 5A and 5B is provided.

In process 500, sampling-based approximations are introduced to deal with a large M. Specifically, D is sampled according to the prior distribution q and seek to find the maximizer of:

$${max}_{π ∈ Π} {min}_{ξ ∈ {𝒰}_{α , q ( D )}} \hat{f} ( π , ξ ) \qquad EQUATION 4$$

which can be solved using process 400.

As in VariBAD, the policy π_{ψ} is made history-dependent by providing, as an input to the policy, the belief vector bₜ and state sₜ. The history of observations is encoded into the belief by the use of a variational auto-encoder (VAE), which is a combination of an encoder Enc_{ϕ} 210 and a decoder Dec_{ϕ} 220. Unlike VariBAD, in which the evidence lower bound (ELBO) is maximized, the CVaR of return R is maximized so that with the parameterization of VariBAD, the objective can be written as

$${max}_{ψ , ϕ , θ} = \{ {min}_{ξ ∈ {𝒰}_{α , q}} {𝔼}^{q} [ ξ ( M ) {CVaR}_{αξ ( M )} [ R ( ψ , ϕ , θ ) \vert M ] ] + λ {𝔼}^{q} [ {\sum }_{t = 0}^{T} {ELBO}_{t} ( ϕ , θ ) ]$$

Similar to VariBAD, the policy and VAE can be optimized alternatingly.

The policy optimization is:

$${max}_{ψ} {min}_{ξ ∈ {𝒰}_{α , q}} {𝔼}^{q} [ ξ ( M ) {CVaR}_{αξ ( M )} [ R ( ψ , ϕ , θ ) \vert M ] ] \qquad EQUATION 5$$

The VAE optimization is:

$${max}_{ϕ , θ} {𝔼}^{q} [ {\sum }_{t = 0}^{T} {ELBO}_{t} ( ϕ , θ ) ] \qquad EQUATION 6$$

where R(ψ|ϕ, θ) represents the return with policy π_{ψ} when the belief vector bₜ is encoded with encoder Enc_{ϕ} 210 and decoded with decoder Dec_{ϕ} 220, which are fixed during policy optimization. For ELBOₜ (ϕ, θ), the VariBAD approach is employed, which leads to process 500 in FIGS. 5A, 5B.

The process 500 begins with the inputting of an initial policy parameter ψ to be evaluated in 510 along with the inputting of with a sample size K of MDPs to be sampled in 520. The sample size K is a design choice that is typically based upon available resources. As the sample size K increases, more resources are needed to perform the process 500.

In 530, K number of MDPs are sampled from a prior distribution q. In other words, based upon prior knowledge of the environment, certain MDPs can be selected.

In 540, the policy π is evaluated. The evaluation of the policy π includes, in 541, an optional operation of resampling a K number of MDPs from the prior distribution q. Then, in 543, each sample in the K number of MDPs is evaluated as follows. In 545, behavior data β(m, π) is collected for the current policy π_{ψ} by interacting with the environment m using the current policy π_{ψ}. This includes the encoder Enc_{ϕ} 210 mapping the history hₜ (s₀,a₀, s₁,a₁, s₂,a₂ . . . sₜ,aₜ) of state-action pairs into a belief vector bₜ.

In 547, a respective critic 230 (implemented as a neural network) for each of the MDPs from the K sample of MDPs evaluates the performance of the current policy π_{ψ}. This evaluation includes outputting an estimated quantile function of return F_{m,ψ}⁻¹ based upon the behavior data β(m, π) collected by the current policy π_{ψ} for each of the MDPs from the K sample of MDPs. This represents a change from VariBAD, in which a single critic outputs the estimated average expected return.

In 549, a determination is made as to whether each of the MDPs from the K sample of MDPs has been evaluated. If not, the evaluation of the policy 540 returns to 543 to select another MDP from the K sample of MDPs. If yes, the process 500 proceeds to optimize the policy in 550.

In 550 the policy π is optimized. This includes updating the weight ξ for each MDP and updating the policy parameter ψ. Updating the weight ξ can involve solving the inner minimization problem of Equation 4 by an augmented Lagrangian method where

$${CVaR}_{β}^{{π}_{ψ}} [ R \vert m ] = \frac{1}{β} {\int }_{0}^{β} {F}_{m , ψ}^{- 1} ( t ) dt$$

Using the updated weight ξ, the policy can be updated as follows:

$${\sum }_{m ∈ D} ξ ( m ) {CVaR}_{αξ ( m )}^{π} [ R \vert m ] \qquad EQUATION 7$$

With sample approximation, the policy parameter ψ can be updated in a manner that improves weighted average performance, which is given by:

$${\sum }_{m ∈ D} ξ ( m ) {CVaR}_{αξ ( m )}^{{π}_{ψ}} [ R \vert m ] \qquad EQUATION 8$$

Specifically, policy parameter ψ can be updated using a gradient-based method where the gradient is given as follows:

$${∇}_{ψ} J \approx \frac{1}{\vert D \vert} {\sum }_{m ∈ D} \frac{ξ ( m )}{\vert β ( m ) \vert} {\sum }_{( s , a ) ∈ β ( m )} {∇}_{ψ} log {π}_{ψ} ( a \vert s ) {\hat{A}}_{αξ ( M )} ( s , a \vert m ) \qquad EQUATION 9$$

In 560, the VAE can be optimized by updating ϕ, θ to increase average ELBO, which is formally represented as follows.

$$\frac{1}{\vert D \vert} {\sum }_{m ∈ D} {\sum }_{t} {ELBO}_{t} ( ϕ , θ ; β ( m ) ) \qquad EQUATION 10$$

In 570, if a stopping condition is not met, the process 500 returns to 540 in which another MDP m from the MDP space M is selected. Otherwise, the process ends at 580. Examples of stopping conditions can include, but are not limited to: a predetermined number of iterations is reached, a predetermined time limit is reached, the differences between the policy in the previous iteration and the current policy is smaller than a predetermined threshold value, and/or the difference between the weight in the previous iteration and the current weight is smaller than a predetermined threshold value.

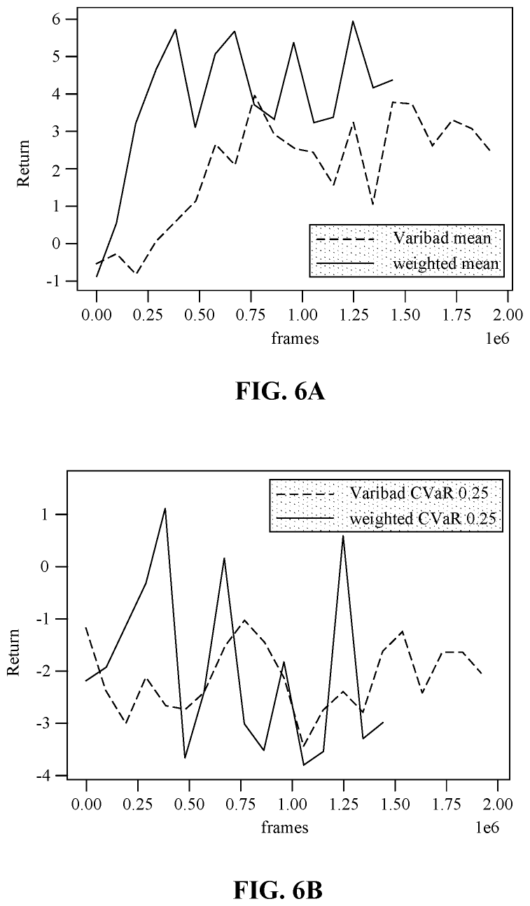

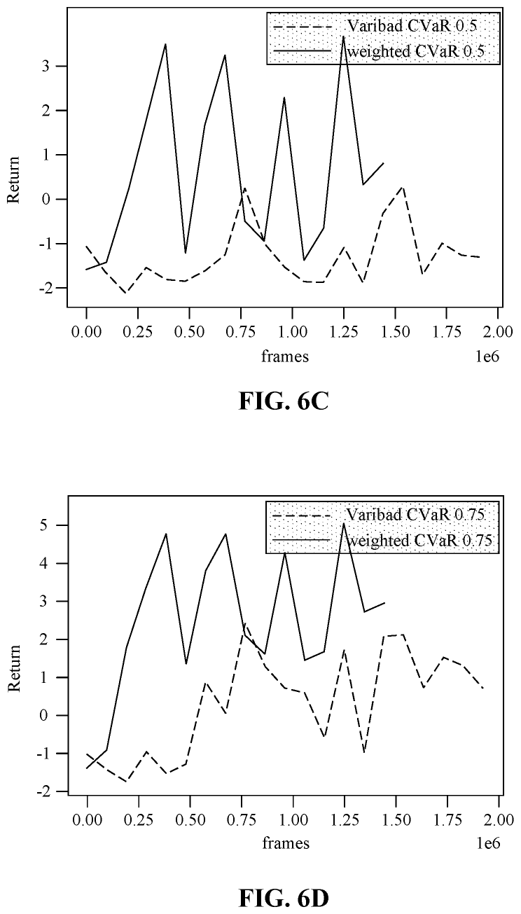

FIGS. 6A-6D illustrates experimental results of the present approach as compared to the VariBAD approach. As shown, the present approach compares favorably to the VariBAD approach as providing a greater return over the number of steps.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

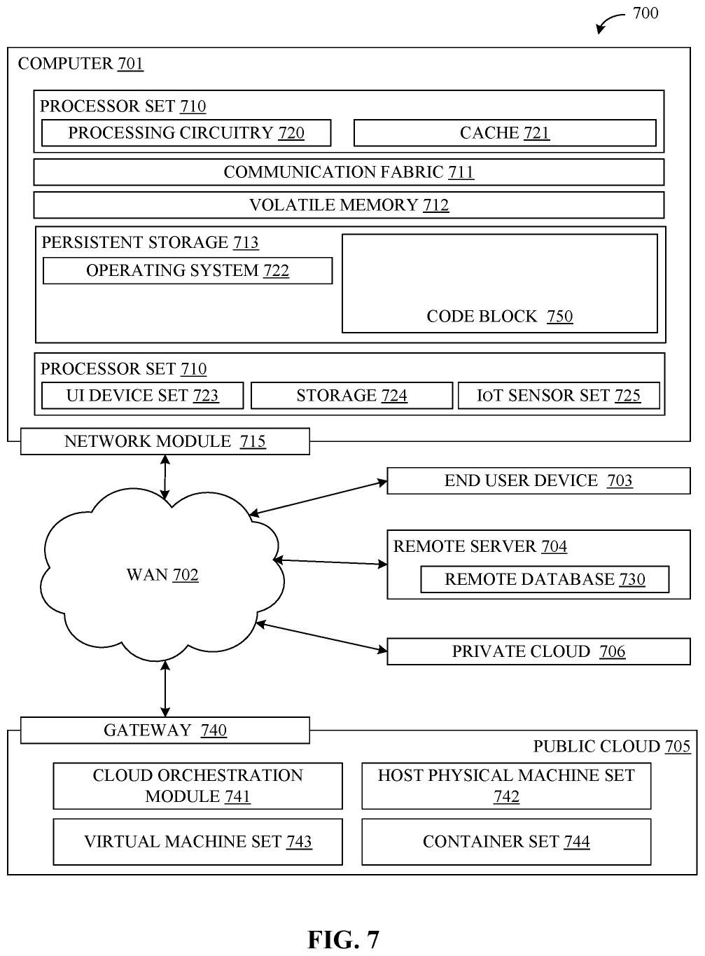

Referring to FIG. 7, computing environment 700 contains an example of an environment for the execution of at least some of the computer code involved in performing the inventive methods, such as code block 750 for implementing a modified VariBAD architecture. Computing environment 700 includes, for example, computer 701, wide area network (WAN) 702, end user device (EUD) 703, remote server 704, public cloud 705, and private cloud 706. In certain aspects, computer 701 includes processor set 710 (including processing circuitry 720 and cache 721), communication fabric 711, volatile memory 712, persistent storage 713 (including operating system 722 and method code block 750), peripheral device set 714 (including user interface (UI), device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

Computer 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. However, to simplify this presentation of computing environment 700, detailed discussion is focused on a single computer, specifically computer 701. Computer 701 may or may not be located in a cloud, even though it is not shown in a cloud in FIG. 7 except to any extent as may be affirmatively indicated.

Processor set 710 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In certain computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in code block 750 in persistent storage 713.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 711 is the signal conduction paths that allow the various components of computer 701 to communicate with each other. Typically, this communication fabric 711 is made of switches and electrically conductive paths, such as the switches and electrically conductive paths that make up busses, bridges, physical input/output ports and the like. Other types of signal communication paths may be used for the communication fabric 711, such as fiber optic communication paths and/or wireless communication paths.

Volatile memory 712 is any type of volatile memory now known or to be developed in the future. Examples include dynamic type random access memory (RAM) or static type RAM. Typically, the volatile memory 712 is characterized by random access, but this is not required unless affirmatively indicated. In computer 701, the volatile memory 712 is located in a single package and is internal to computer 701. In addition to alternatively, the volatile memory 712 may be distributed over multiple packages and/or located externally with respect to computer 701.

Persistent storage 713 is any form of non-volatile storage for computers that is now known or to be developed in the future. The non-volatility of the persistent storage 713 means that the stored data is maintained regardless of whether power is being supplied to computer 701 and/or directly to persistent storage 713. Persistent storage 713 may be a read only memory (ROM), but typically at least a portion of the persistent storage 713 allows writing of data, deletion of data and re-writing of data. Some familiar forms of persistent storage 713 include magnetic disks and solid state storage devices. Operating system 722 may take several forms, such as various known proprietary operating systems or open source Portable Operating System Interface type operating systems that employ a kernel. The code included in code block 750 typically includes at least some of the computer code involved in performing the inventive methods.

Peripheral device set 714 includes the set of peripheral devices for computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some aspects, storage 724 may take the form of a quantum computing storage device for storing data in the form of qubits. In aspects where computer 701 is required to have a large amount of storage (for example, where computer 701 locally stores and manages a large database) then this storage 724 may be provided by peripheral storage devices designed for storing very large amounts of data, such as a storage area network (SAN) that is shared by multiple, geographically distributed computers. Internet-of-Things (IoT) sensor set 725 is made up of sensors that can be used in IoT applications. For example, one sensor may be a thermometer and another sensor may be a motion detector.

Network module 715 is the collection of computer software, hardware, and firmware that allows computer 701 to communicate with other computers through a Wide Area Network (WAN) 702. Network module 715 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 715 are performed on the same physical hardware device. In other aspects (for example, aspects that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any Wide Area Network (for example, the internet) capable of communicating computer data over non-local distances by any technology for communicating computer data, now known or to be developed in the future. In some aspects, the WAN 702 may be replaced and/or supplemented by local area networks (LANs) designed to communicate data between devices located in a local area, such as a Wi-Fi network. The WAN 702 and/or LANs typically include computer hardware such as copper transmission cables, optical transmission fibers, wireless transmission, routers, firewalls, switches, gateway computers and edge servers.

End user device (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In certain aspects, EUD 703 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704. As defined herein, the term “server” means a data processing system configured to share services with one or more other data processing systems.

Public cloud 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 706 is similar to public cloud 705, except that the computing resources are only available for use by a single enterprise. While private cloud 706 is depicted as being in communication with WAN 702, in other aspects, a private cloud 706 may be disconnected from the internet entirely (e.g., WAN 702) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 705 and private cloud 706 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A computer-implemented method for modifying a current policy using reinforcement learning (RL), comprising:
sampling a number, corresponding to an inputted sample size, of Markov Decision Processes (MDPs) defining an environment;
for each of the sampled MDPs,
collecting behavior data for the current policy,
determining a quantile function of return with the current policy using the collected behavior data, and
generating a current weight by updating a weight for a particular sampled MDP using the quantile function of return for the particular sampled MDP; and
modifying the policy based upon the current weight for each of the sampled MDPs.

2. The method of claim 1, wherein
the current weights are generated by minimizing a conditional value of at risk (CVaR) of a return of the current policy, and
the policy is modified to maximize a weighted average of the CVaR of the return with the current weights.

3. The method of claim 2, wherein
a variational auto-encoder (VAE) including an encoder and a decoder is optimized using the collected behavior data.

4. The method of claim 3, wherein
the VAE is optimized by maximizing an evidence lower bound (ELBO).

5. The method of claim 2, wherein
the sampled MDPs are sampled based upon a prior distribution of the environment.

6. The method of claim 2, wherein
the weight is updated by solving an optimization problem.

7. The method of claim 2, wherein
the quantile function of return is determined using distributional RL.

8. The method of claim 2, wherein
the behavior data is determined for the current policy by interacting with the environment using the current policy.

9. A computer hardware system for modifying a current policy using reinforcement learning (RL), comprising:
a hardware processor configured to perform the following executable operations:
sampling a number, corresponding to an inputted sample size, of Markov Decision Processes (MDPs) defining an environment;
for each of the sampled MDPs,
collecting behavior data for the current policy,
determining a quantile function of return with the current policy using the collected behavior data, and
generating a current weight by updating a weight for a particular sampled MDP using the quantile function of return for the particular sampled MDP; and
modifying the policy based upon the current weight for each of the sampled MDPs.

10. The system of claim 9, wherein
the current weights are generated by minimizing a conditional value of at risk (CVaR) of a return of the current policy, and
the policy is modified to maximize a weighted average of the CVaR of the return with the current weights.

11. The system of claim 10, wherein
a variational auto-encoder (VAE) including an encoder and a decoder is optimized using the collected behavior data.

12. The system of claim 11, wherein
the VAE is optimized by maximizing an evidence lower bound (ELBO).

13. The system of claim 10, wherein
the sampled MDPs are sampled based upon a prior distribution of the environment.

14. The system of claim 10, wherein
the weight is updated by solving an optimization problem.

15. The system of claim 10, wherein
the quantile function of return is determined using distributional RL.

16. The system of claim 10, wherein
the behavior data is determined for the current policy by interacting with the environment using the current policy.

17. A computer program product, comprising:
a computer readable storage medium having stored therein program code for modifying a current policy using reinforcement learning (RL),
the program code, which when executed by a computer hardware system, cause the computer hardware system to perform:
sampling a number, corresponding to an inputted sample size, of Markov Decision Processes (MDPs) defining an environment;
for each of the sampled MDPs,
collecting behavior data for the current policy,
determining a quantile function of return with the current policy using the collected behavior data, and
generating a current weight by updating a weight for a particular sampled MDP using the quantile function of return for the particular sampled MDP; and
modifying the policy based upon the current weight for each of the sampled MDPs, wherein
the current weights are generated by minimizing a conditional value of at risk (CVaR) of a return of the current policy, and
the policy is modified to maximize a weighted average of the CVaR of the return with the current weights.

18. The computer program product of claim 17, wherein
a variational auto-encoder (VAE) including an encoder and a decoder is optimized using the collected behavior data, and
the VAE is optimized by maximizing an evidence lower bound (ELBO).

19. The computer program product of claim 17, wherein
the weight is updated by solving an inner minimization problem.

20. The computer program product of claim 17, wherein
the quantile function of return is determined using distributional RL.
